(19) United States
(12) Patent Application Publication
(10) Pub. No.: US 2016/0055145 A1
(43) Pub. Date: Feb. 25, 2016

(54) ESSAY MANAGER AND AUTOMATED PLAGIARISM DETECTOR

(71) Applicants: Sandeep Chauhan, Hayward, CA (US); Alexander Thaler, Oakland, CA (US)

(72) Inventors: Sandeep Chauhan, Hayward, CA (US); Alexander Thaler, Oakland, CA (US)

(21) Appl. No.: 14/830,654

(22) Filed: Aug. 19, 2015

Related U.S. Application Data
(60) Provisional application No. 62/039,160, filed on Aug. 19, 2014.

(51) Int. Cl. G06F 17/27

(52) U.S. Cl. CPC G06F 17/2725

(57) ABSTRACT

Methods, systems, and apparatus, including computer programs encoded on a computer storage medium, for essay managing and plagiarism detecting are disclosed. A method includes receiving one or more essay drafts in response to an essay prompt that is provided by an online college application. The method includes determining one or more subject-verb pairs and one or more adjective-noun pairs for the one or more essay drafts by parsing the one or more essay drafts. The method includes storing the one or more essay drafts and the one or more subject-verb pairs and one or more adjective-noun pairs for the one or more essay drafts. The method includes receiving an additional essay draft in response to an additional essay prompt that is provided by an additional online college application. The method includes determining one or more additional subject-verb pairs and one or more additional adjective-noun pairs for the additional essay draft.

### CROSS REFERENCE TO RELATED APPLICATION

This application claims the benefit of U.S. Patent Application Ser. No. 62/039,160, filed on Aug. 19, 2014, the contents of which are incorporated by reference

### TECHNICAL FIELD

This specification generally relates to the field of educational technology, specifically, college planning software.

### BACKGROUND

To apply to colleges, students typically fill out applications online. The applications may include one or more essay prompts accompanied by a text input box. The student may type the essay directly into the text box or cut and paste the essay from another application such as a word processing application.

### SUMMARY

In general, one aspect of the subject matter described in this specification may include techniques for essay management and plagiarism detection. A method includes the actions of receiving one or more essay drafts in response to an essay prompt that is provided by an online college application; determining one or more subject-verb pairs and one or more adjective-noun pairs for the one or more essay drafts by parsing the one or more essay drafts; storing the one or more essay drafts and the one or more subject-verb pairs and one or more adjective-noun pairs for the one or more essay drafts; receiving an additional essay draft in response to an additional essay prompt that is provided by an additional online college application; determining one or more additional subject-verb pairs and one or more additional adjective-noun pairs for the additional essay draft by parsing the additional essay draft; determining a correlation score between (i) the one or more additional subject-verb pairs and the one or more additional adjective-noun pairs and (ii) the one or more subject-verb pairs and the one or more adjective-noun pairs; determining whether the correlation score satisfies a threshold correlation score; and based on determining whether the correlation score satisfies the threshold correlation score, determining whether to label the additional essay draft as disguised plagiarism that indicates the additional essay draft includes similar subject-verb and adjective-noun structures without including identical words.

The method may include one or more of the following optional features. The actions further include based on determining whether to label the additional essay draft as disguised plagiarism, determining a text string score between text strings from the one or more essay drafts and additional text strings from the additional essay draft; determining whether the text string score satisfies a threshold text string score; and based on determining whether the text string score satisfies the threshold text string score, determining whether to label the additional essay draft as actual plagiarism that indicates word for word similarities between the additional essay draft and the one or more essay drafts. The action of determining whether the correlation score satisfies a threshold correlation score includes determining that the correlation score satisfies a threshold correlation score. The action of determining whether to label the additional essay draft as actual plagiarism includes determining to label the additional essay draft as actual plagiarism.

The actions further include preventing a user who previously edited the additional essay draft from further editing the additional essay draft. The action of determining whether the text string score satisfies a threshold text string score includes determining that the text string score satisfies a threshold text string score. The action of determining whether to label the additional essay draft as disguised plagiarism includes determining to label the additional essay draft as disguised plagiarism. The actions further include providing, for output, a disguised plagiarism warning to a user who previously edited the additional essay draft that indicates to the user possible disguised plagiarism. The online college application is an application to apply to a first institution and the additional college application is an application to apply to a second, different institution. The actions further include receiving, from a user inputting the additional essay draft, a request for an additional user to review the additional essay draft, the request including an email address of the additional user.

The actions further include receiving data indicating a deadline associated with the additional essay draft determining whether a number of days between a current date and the deadline satisfies a deadline threshold; and based on determining whether the number of days between the current date and the deadline satisfies the deadline threshold, determining whether to provide, for output, a deadline warning. The actions further include receiving data indicating a maximum word count for an essay prompt associated with the additional essay draft; determining whether a word count difference between a current word count for the additional essay draft and the maximum word count satisfies a word count threshold; and based on determining whether the word count difference between the current word count for the additional essay draft and the maximum word count satisfies the word count threshold, determining whether to provide, for output, a word count warning.

In general, another aspect of the subject matter described in this specification may include techniques for essay management and plagiarism detection. A method includes the actions of receiving, by a server, a request to create an account for a student; receiving, by the server, a request to associate a school with the account; receiving, by the server, a request to select the school to view the essay prompts for the school; receiving, by the server, a selection of one of the essay prompts; providing, by the server and for display in a browser, the selected essay prompt and a text editor; receiving, by the server, from a browser running in a device associated with the student, and through the text editor, a draft of an essay that is associated with the selected essay prompt; receiving, by the server and from the browser running on the device associated with the student, a request to review, the request including an identifier for a reviewer, wherein the reviewer is not required to have an account; sending, by the server and to a device associated with a reviewer, a request to review.

The actions further include authenticating, by the server, the reviewer; in response to authenticating the reviewer, providing, by the server and to a browser running on the device associated the reviewer, the draft of the essay that is associated with the selected essay prompt; receiving, by the server and from the browser running on the device associated with the reviewer, a revised version of the essay; and storing, by the server, in association with the account, and without requiring creation of a folder by the user, the reviewer or another user, the revised version of the essay with the draft of the essay, an identifier for the revised version of the essay, and an identifier of the reviewer in association with the revised version of the essay; receiving, by the server and from the browser running on the device associated with the student or on a device associated with a counselor of the student, a request to view a report of the essay requirements for a particular school; providing, by the server and to the browser running on the device associated with the student or on a device associated with the counselor of the student, the report of the essay requirements for the particular school, wherein the report includes, for each essay, including the selected essay: essay prompt, program specific essay prompt, a completion status indicator for each essay prompt and program specific essay prompt, an optional label or a required label for each essay prompt and program specific essay prompt, a deadline for each essay prompt and program specific essay prompt, and a number of reviewers for each essay prompt and program specific essay prompt.

The actions further include receiving, by the server and from the browser running on the device associated with the student or on a device associated with the counselor of the student, a request to view essay versions associated with the selected essay prompt; providing, by the server, from the browser running on the device associated with the student or on a device associated with the counselor of the student, and for display in one window of the browser, the essay versions associated with the selected essay prompt including the draft of the essay and the revised version of the essay; receiving a request, by the server and from the browser running on the device associated with the student or on a device associated with the counselor of the student, a request to view a comparison of the revised version of the essay and the draft of the essay; providing, by the server and to the browser running on the device associated with the student or on a device associated with a counselor of the student, the draft of the essay, and an essay illustrating the differences between the revised version of the essay and the draft of the essay; receiving, by the server and from the browser running on the device associated with the counselor of the student, a request to view a progress report for the student; and providing, by the server, and to the browser running on the device associated with the counselor of the student, the progress report, wherein the progress report includes: a number of schools assigned to the student, a number of required essays, a number of reviewers who have reviewed the student's essays, a list of schools assigned to the student, and a number of essays associated with each school on the list of schools.

Other features may include corresponding systems, apparatus, and computer programs encoded on computer storage devices configured to perform the foregoing actions.

The details of one or more implementations are set forth in the accompanying drawings and the description, below. Other features will be apparent from the description and drawings, and from the claims.

### BRIEF DESCRIPTION OF THE DRAWINGS

FIGS. 1-16 illustrate example browser screen shots of the essay manager and plagiarism detector.

FIGS. 17 and 17A are flow charts of example processes for routing messages.

Like reference numbers and designations in the various drawings indicate like elements.

### DETAILED DESCRIPTION

This application describes a standalone essay management system that automates plagiarism detection and essay management, accomplishing the dual aims of enabling student tracking in this area while preserving the integrity of the college admissions process and allows users (counselors and students) to quickly identify the essay requirements for their School List and draft, edit, and share essays within the program, without having to access any software other than a web browser.

This application also describes an automated and accurate early-warning mechanism that determines which students are at risk for missing their college application deadlines and presents that information in a table accessible by counselors or administrators.

The college application process is complex and requires the completion of a series of interrelated tasks, some of which may be performed by students or counselors or both. The process can be divided into two phases: 1) the identification of schools to which the student is interested in applying (“School List”), and 2) the completion of applications and associated actions required to finalize those applications.

Application essays, a requirement for many college applications, are widely considered the most time-consuming and anxiety-provoking part of process. Application essay requirements often vary by school. For example, if a student is applying to Harvard, Yale, and USC, twelve distinct essays would be required to complete the student's applications. Application essay and deadline requirements are spread out across the internet and are often difficult to locate. Without a centralized repository of essay requirements, students spend days and sometimes weeks finding essay requirements and their accompanying word count limits, serving as a substantial barrier to the successful completion of college applications. Students who have located their essay requirements are encouraged—i.e. by the College Board, a key institution in the college application landscape—to invest time in polishing their essays and to solicit help from counselors, teachers, parents, and other individuals who can help them refine their essays. Students therefore often create several drafts of each essay, each of which must be saved as a file into a preexisting folder or a new folder created for that purpose. If a counselor is working with a student on her essays, the counselor will be unable to identify and access the most current drafts unless the student sends those drafts to her by email attachment, or the files are synced online and are titled in a way that allows the counselor to identify them. Either method presents its own significant challenges in terms of document management, especially for college counselors, whose role is widely viewed as encompassing the act of assisting students with all aspects of their college applications, including the essays.

This application describes a college planning and essay management tool for students and counselors. The technology automates document management while providing a plagiarism-free environment for crowdsourcing essay reviews and tracking student progress.

Within the program a user and the user's counselor can create college lists and view all of the application essay and deadline requirements for that list. When the user is ready to start working on the essay, the essay management system organizes all of the user's drafts, including any reviewed drafts submitted by a third party, without having to create files or folders.

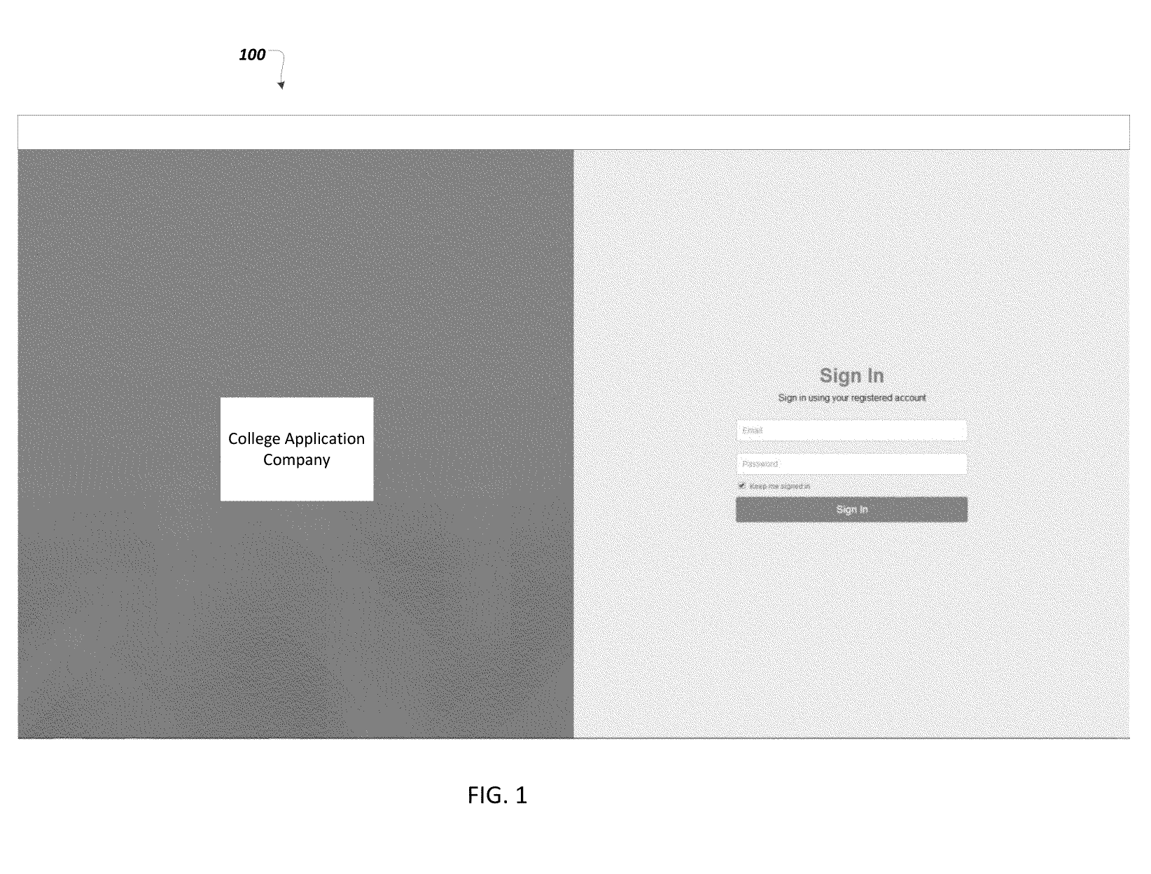

FIG. 1 illustrates an example screen shot 100 of the essay management and message routing system. Screen shot 100 illustrates a user login screen. The user enters the user's email and the password that has been assigned to the user. The user will be taken to a screen that allows the user to change the password, if that option is selected.

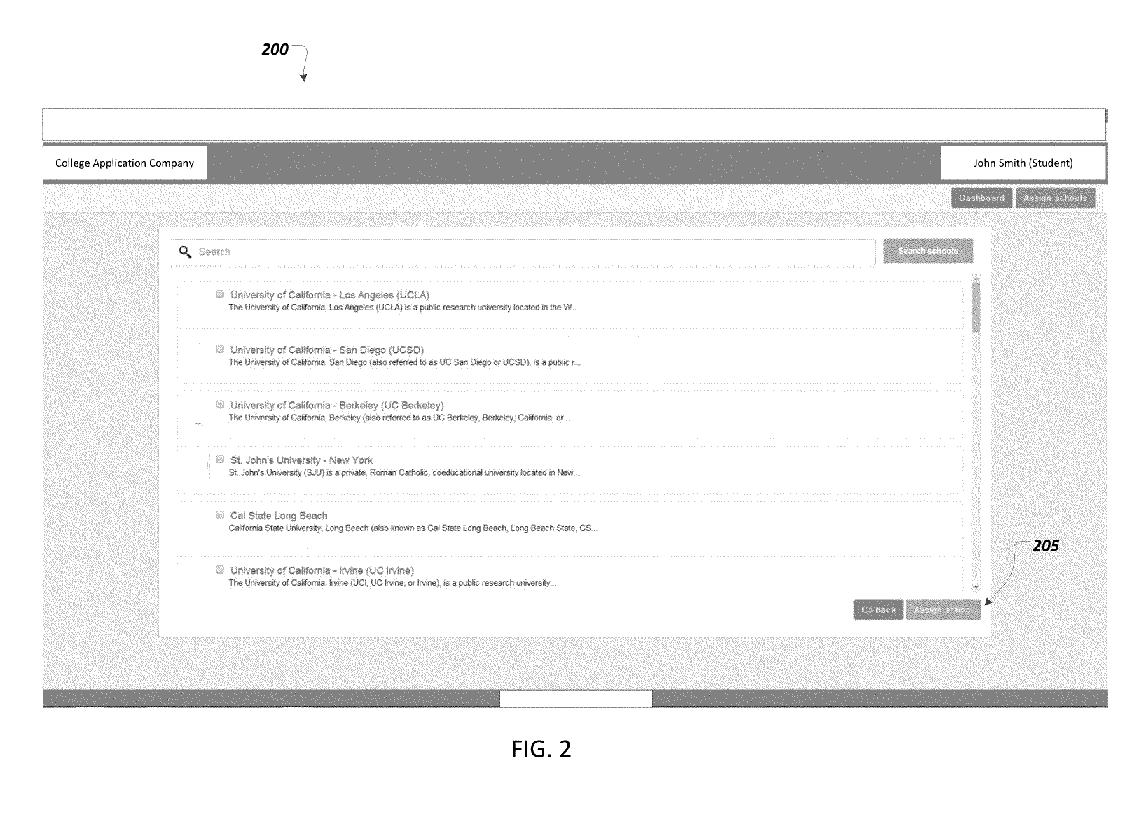

FIG. 2 illustrates an example screen shot 200 of the essay management and message routing system. Screen shot 200 illustrates a screen for the user to search for schools and to add schools to the user's list. A user searches for schools using the search box. To view admissions stats and other information about a particular school, the user can select the school name (in blue). When the user is ready to add a school to the user's list, the user selects the checkbox to the left of the school name and clicks the button 205 labeled “Assign school.”

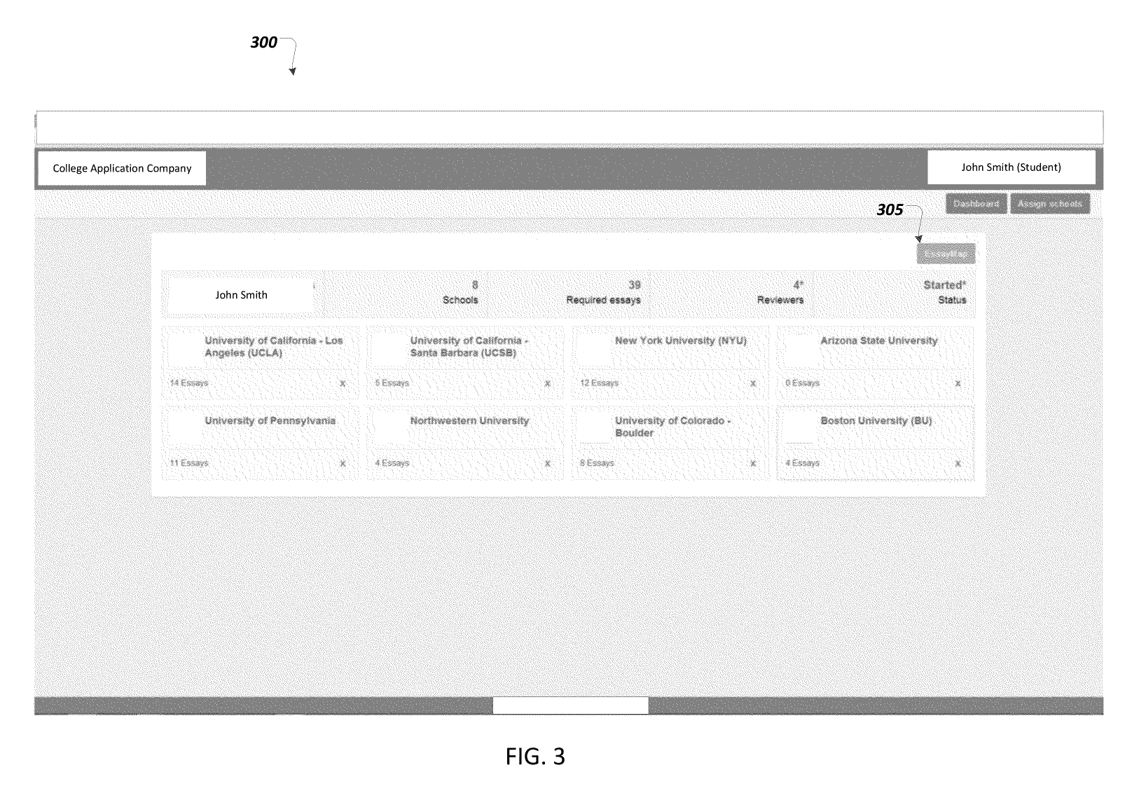

FIG. 3 illustrates an example screen shot 300 of the essay management and message routing system. Screen shot 300 illustrates the schools assigned to a particular user, in this instance, John Smith. The user may select button 305 to create a report containing all of the essay and deadline requirements for the schools in the user's list.

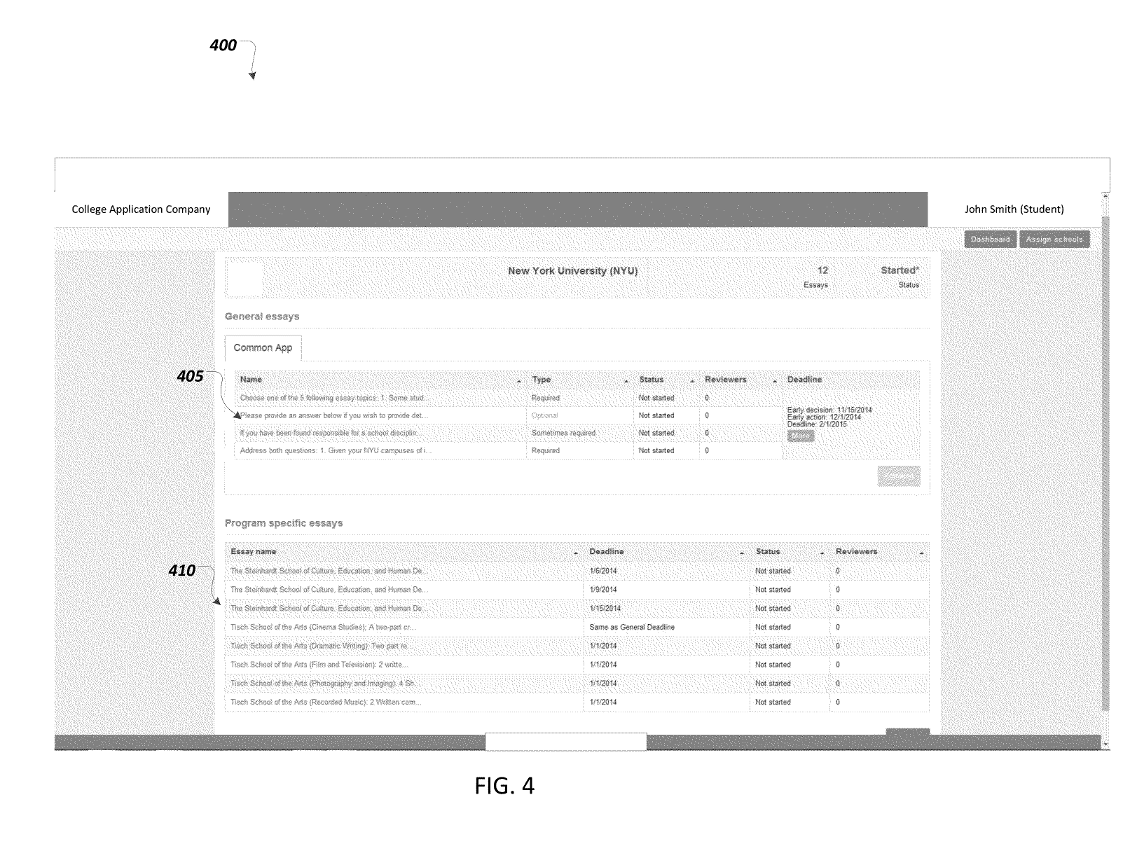

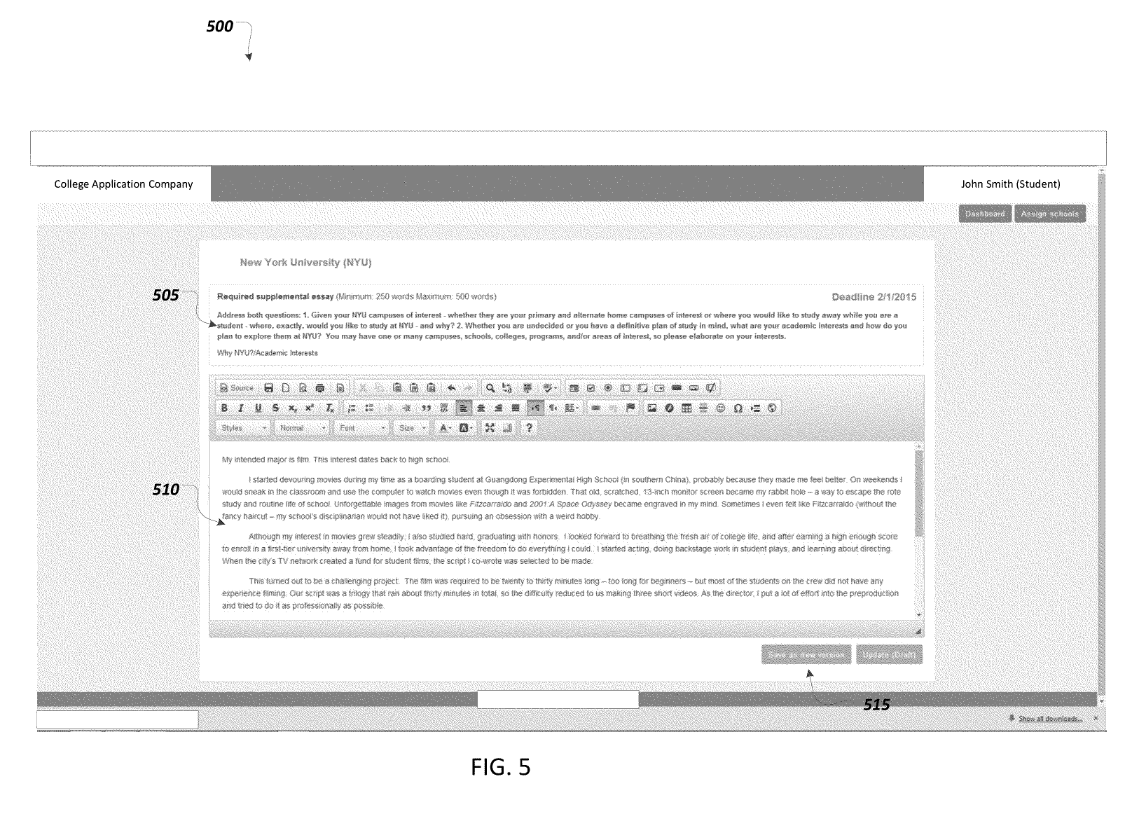

FIG. 4 illustrates an example screen shot 400 of the essay management and message routing system. Screen shot 400 illustrates the essay requirements for a particular school, in this instance, New York University. At the top of screen shot 400, the total number of essays required for the school, as well as the status of the school—not started, started, finalized—is represented. In screen shot 400, the user can see all of the essay requirements in section 405 for the selected school; each essay requirement is identified as “Required,” “Optional,” or “Sometimes Required” (conditionally required). Users can mark the optional essays they intend to submit—an essay marked in this manner will be considered “required” by the system, affecting when the school is considered finalized. Within section 405 (and 410) the “Status” of each essay—not started, started, pending review, finalized, etc.—is displayed, as well as the number and identity of reviewers to which the essay has been sent as described in detail below. If a selected school has separate essay requirements or a program or department of the school has separate essay requirements, they will be listed in section 410. If a school accepts more than one application, users can toggle between the different accepted applications and view the distinct essay requirements required for each. A default application is automatically selected for purposes of tracking when the essays for a school are finalized, but the user can select any other accepted application by clicking the “work within this application” button associated with the relevant application.

The area represented by screen shot 400 may also be used to represent non-essay application requirements such as, but no limited to, portfolio requirements, recommendation requirements, short answer responses, and standardized test requirements, requirements to submit non-written media, grade point average requirements, and course requirements. When all of the requirements for a particular school have been met, that school may be marked as “completed” and represented in the student and counselor dashboards as such.

When the user is ready to work on the essays for a school on the list, the user can select any of the displayed essays. In some implementations, the school should be added to the user's list before the user can work on it. For example, if the user would like to work on NYU's required supplemental essay, click on NYU and click on the required supplemental essay.

FIG. 5 illustrates an example screen shot 500 of the essay management and message routing system. Screen shot 500 illustrates the essay management system with an example essay prompt 505 and text editor 510. At the top of the screen 500 is the selected essay prompt 505 and the deadline for the school. Below is a “working sheet” with a text editor 510. The working sheet is where the user can create the first version of the essay and create subsequent versions or drafts. The user can work within the text editor 510 or copy and paste from another program. When the user is ready to save a new version, the user can select button 515.

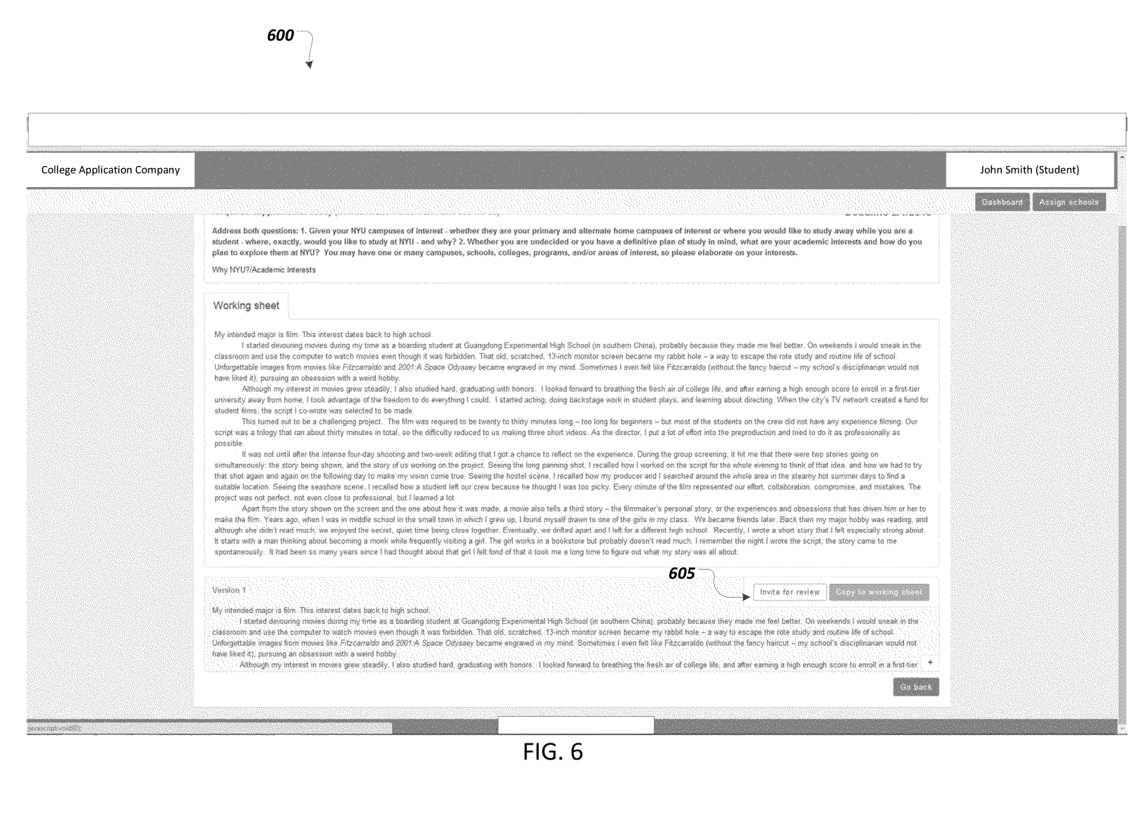

FIG. 6 illustrates an example screen shot 600 of the essay management and message routing system. The screen shot 600 illustrates the working sheet with a version of the essay below the working sheet. Once the user has created a version, she may share it anyone, including but not limited to 1) an assigned counselor, 2) any third party with an email address, or 3) another user of the essay management system. The reviewer does not need to have an account with system. In instances in which a review request is sent by email, the reviewer receives an email containing a link to a text editor containing the content of the essay he/she was invited to review. The reviewer then has the opportunity to contribute content in the form of revisions, comments, suggestions, changes, etc. A separate window for “comments” and other non-line-item revisions may be provided. The reviewer may either save any changes within the text editor, which allows her for example to return to the essay at a later time and continue working, or may upload the essay to the essay management system. A related invite system may be applied at the school level (see screen shot 400) such that a user can invite a reviewer to view all of the application essay requirements and non-essay requirements associated with a particular school. It may also be applied at the application level, such that a user can invite a reviewer to view all of the application requirements for all of the schools on a student's list.

A user may also “crowdsource” reviews of the user's essay versions by submitting them to all other users on the system using a separate invite function designed for this purpose. In some implementations, in order to use this feature the user must first provide the required number of reviews of other users' essay versions. The number required in any particular instance would be determined in relation to the demand for reviews at the time the review request was made, such the total number of outstanding review requests would be approximately equal to the total number of required reviews at any point in time, achieving supply-demand equilibrium.

Plagiarism of college application essays is a significant challenge affecting the integrity of the college application process. It may be difficult for humans to reliably detect various forms of plagiarism, and detection may be dependent on the particular individual performing the check. In some implementations, some colleges may compare essay drafts submitted by college applicants with a database of documents. The database of documents may only include prior year essay submissions and may be limited to essays submitted to a particular college.

The Essay Management System detects both copy-and-paste plagiarism and disguised plagiarism that occurs within the system by applying a two-tiered analysis of versions created by users who have reviewed other users' essays (i.e., at the precise moment that plagiarism occurs).

When an essay version is submitted to any other user (either by email, crowdsourcing, or some other mechanism), it is tagged as “Source Material,” an original, un-plagiarized document. The Essay Management System parses each instance of Source Material syntactically to create a map of subject-verb and adjective-noun pairs. Any subsequent versions created by the reviewer (“Non-Source Material”) are also parsed to create a similar map, which is then compared against the map of the Source Material.

If the comparison reveals similarities that exceed a predetermined threshold, a second check is performed by selecting a randomized set of strings from the Source Material and comparing them against duplicative instances of those strings in the Non-Source Material. If this second comparison does not reveal similarities that exceed a predetermined threshold, the reviewer is issued a warning regarding disguised plagiarism. If the comparison exceeds the predetermined threshold, the Non-Source Material is tagged as “plagiarized” and the reviewer is locked out of the draft.

Because similarly positioned verb-subject and adjective-noun pairs is a necessary condition of plagiarism (but not a sufficient one), this two-step system has the benefit of detecting possible disguised plagiarism and actual plagiarism while conserving computational resources. Furthermore, all drafts are time-stamped, facilitating further review of any potential instance of plagiarism.

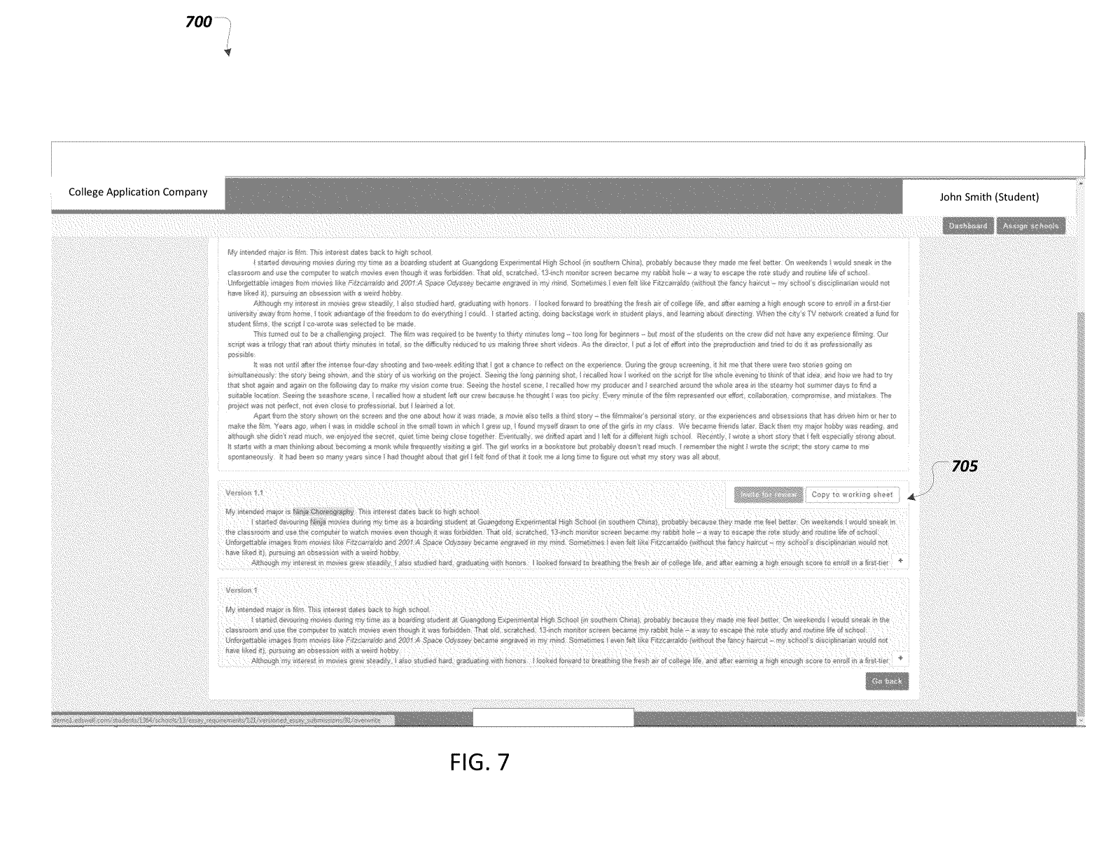

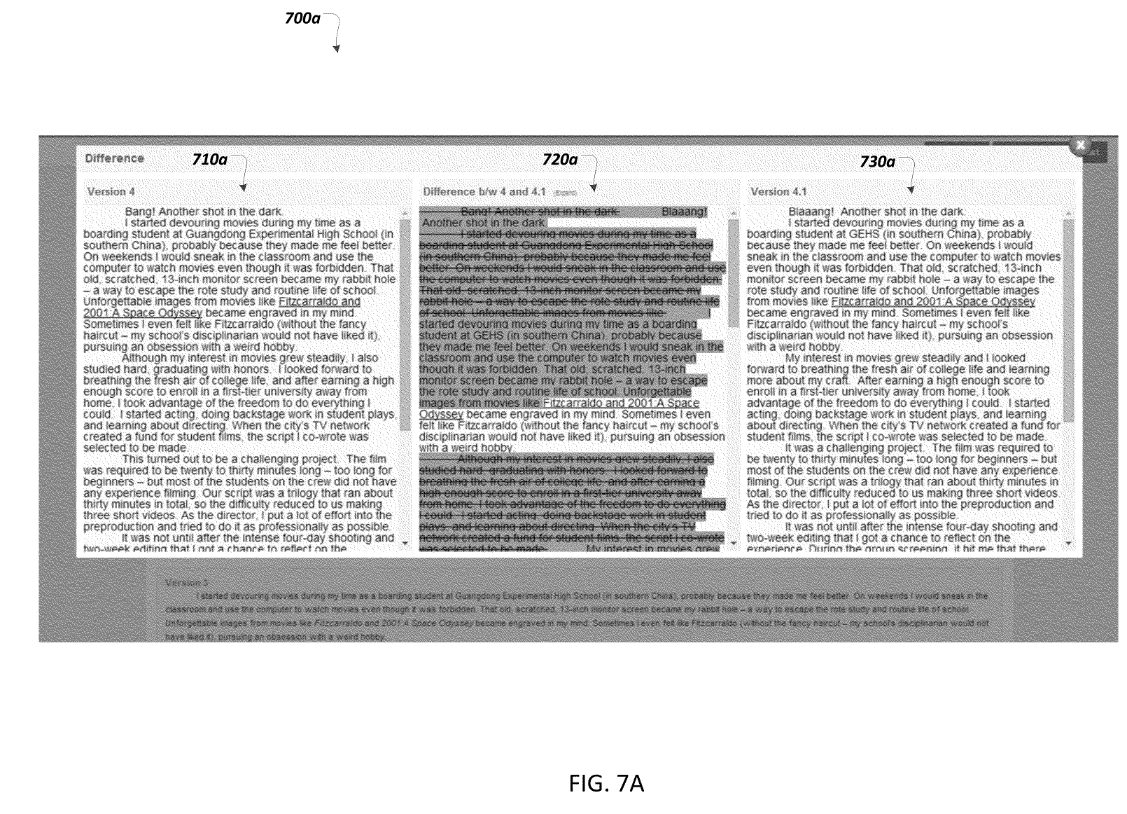

FIG. 7 illustrates an example screen shot 700 of the essay management and message routing system. The screen shot 700 illustrates the working sheet with a version of the essay below the working sheet. Below the working sheet is a version 1.1, which represents a draft that has been uploaded by a reviewer and automatically inserted above Version 1 (the draft to which the reviewer was invited). A user can copy any version, including a reviewer's version, to the user's working sheet by clicking button 705. This is useful if the user would like to incorporate some of the reviewer's comments/edits into a new version. A user can also view any differences between a version and a version submitted by a reviewer by clicking the “Get differences” button, which displays the version, the version submitted by the reviewer, and a third draft that identifies the differences between the two, all in a side-by-side format as shown in FIG. 7A.

FIG. 7A illustrates and example screen shot 700a of the essay management and message routing system. The screen shot 700a illustrates different versions of an essay. Essay 710a is a version created by the student. In this particular instance, essay 710a is the fourth version of the essay. Essay 730a is an edited version of essay 710a that a reviewer edited. Difference essay 720a illustrates the differences between essay 710a and essay 730a. As illustrated in difference essay 720a, text that was removed by the reviewer may be shown as crossed out or highlighted in a particular color or both. Text that was added by the reviewer may be shown as underlined or highlighted in a different color or both. In some implementations, the user may select any two essay versions to compare in a screen similar to screen shot 700a.

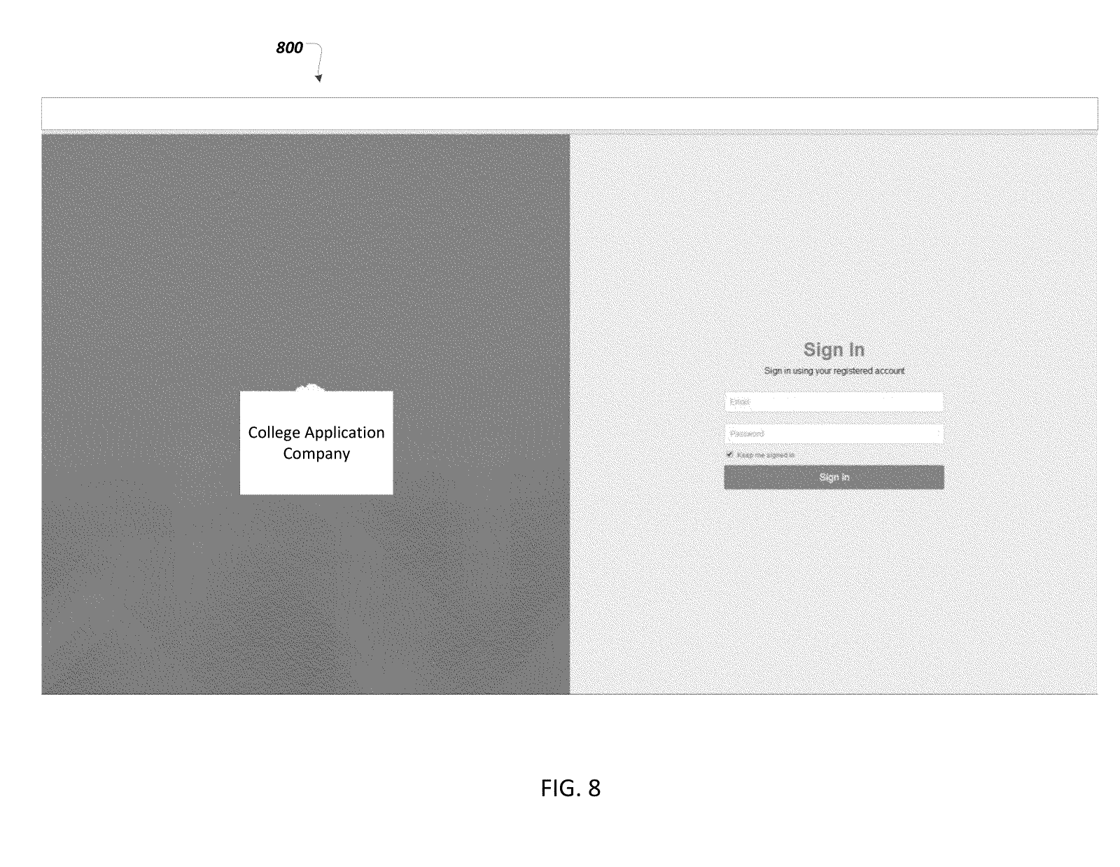

FIG. 8 illustrates an example screen shot 800 of the essay management and message routing system. The screen shot 800 illustrates a login screen similar to FIG. 1.

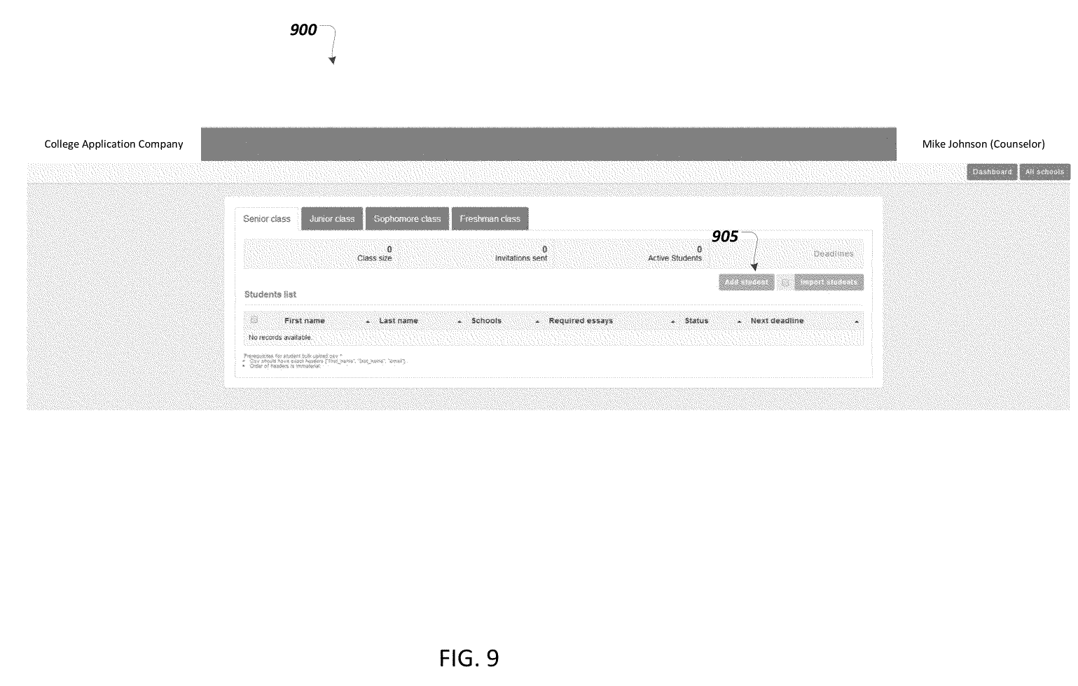

FIG. 9 illustrates an example screen shot 900 of the essay management and message routing system. The screen shot 900 illustrates a dashboard for a counselor who is working with a number of other users or students. In the upper left area of screen 900 each class is represented by a tab. The senior class is automatically selected. To add a student to the class, select the appropriate tab (Senior, Junior, Sophomore, Freshman) and click the green “Add student” button 905. Enter the student's info in the form. The counselor should provide a temporary password, such as the student's first and last name. When the student logs in, the student will be prompted to change the temporary password. The student may also be prompted to enter biographical and/or academic information into a form, which information can be subsequently transmitted to colleges and/or approved third parties, subject to the student's consent and applicable legal requirements. This information may also be represented in the counselor dashboard to enable counselors and other administrators to sort students by GPA, standardized test score, and any other category of information included in the form.

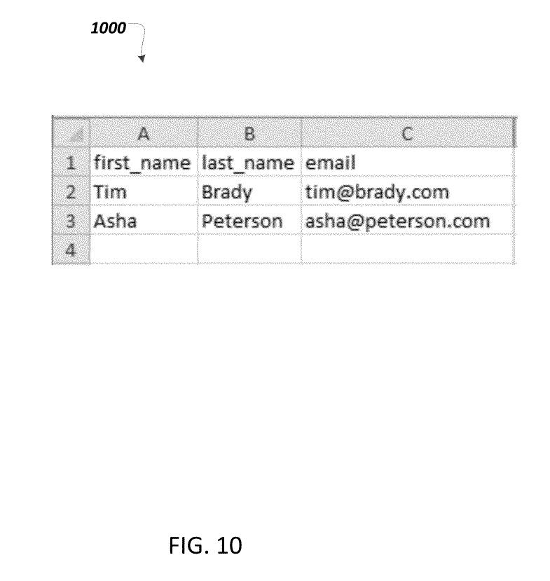

FIG. 10 illustrates an example screen shot 1000 of the essay management and message routing system. Screen 1000 illustrates an example table from which to import students. The counselor can add multiple students at once using the “Import students” button. To import students, the counselor should create a spreadsheet with the following column names: first_name, last_name, email. Below each column header enter the appropriate student info and save the spreadsheet. The ordering of the columns is immaterial, but the column names should match the names above. When the counselor has finished the spreadsheet, the counselor can click the “Import students” button in screen 900 to upload the spreadsheet.

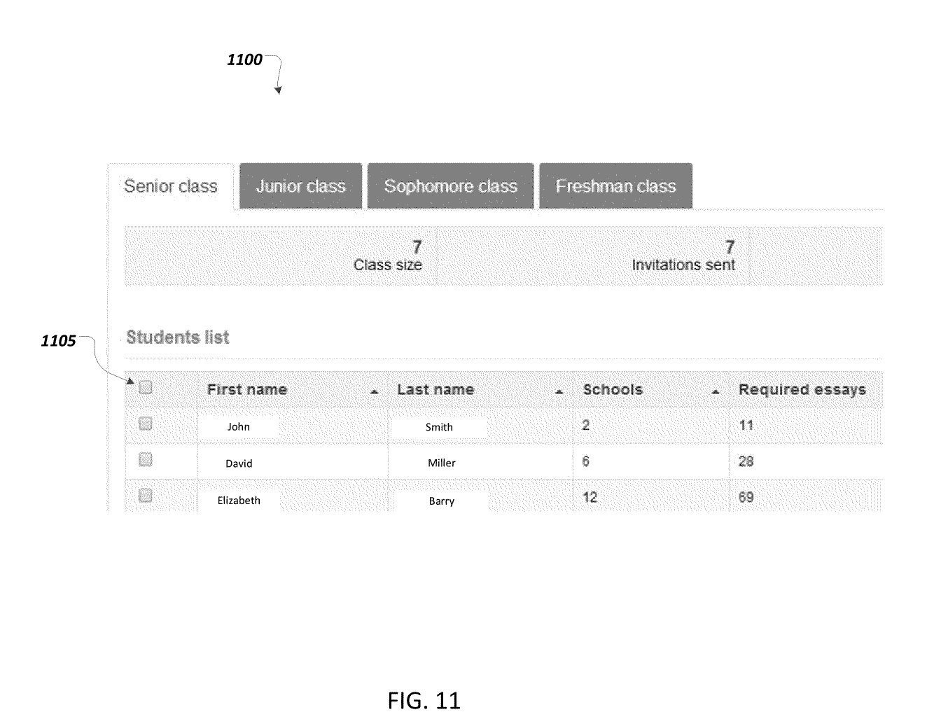

FIG. 11 illustrates an example screen shot 1100 of the essay management and message routing system. Screen 1100 illustrates an example screen for inviting students or users to begin using the system. To give students access to the system, the counselor invites them. First, the counselor selects all the students in the counselor's class by selecting button 1105 or selects only some of the students by selecting only particular students. Next, the counselor clicks the green “Invite” button. The counselor will be taken to an email editor where the counselor can type a note to the counselor's students. When the counselor is done, the counselor may click on the green “Invite” button that may be located in the lower right area. The students will receive an invite email, along with an automatically generated password. When a student logs in for the first time, the student will have an opportunity to change the password if they like. Students who have signed up for the system independently can search for counselors and/or administrators to whose account they would like to be added. They can then click a button requesting that such counselor add them to the system, which request is forwarded to the counselor, along with the requesting student's name, email address, and/or other biographical and/or academic information. The counselor can then either accept or decline the request. Accepting the request adds the requesting student to the counselor's dashboard for the appropriate grade-level, effectively incorporating that student into the class.

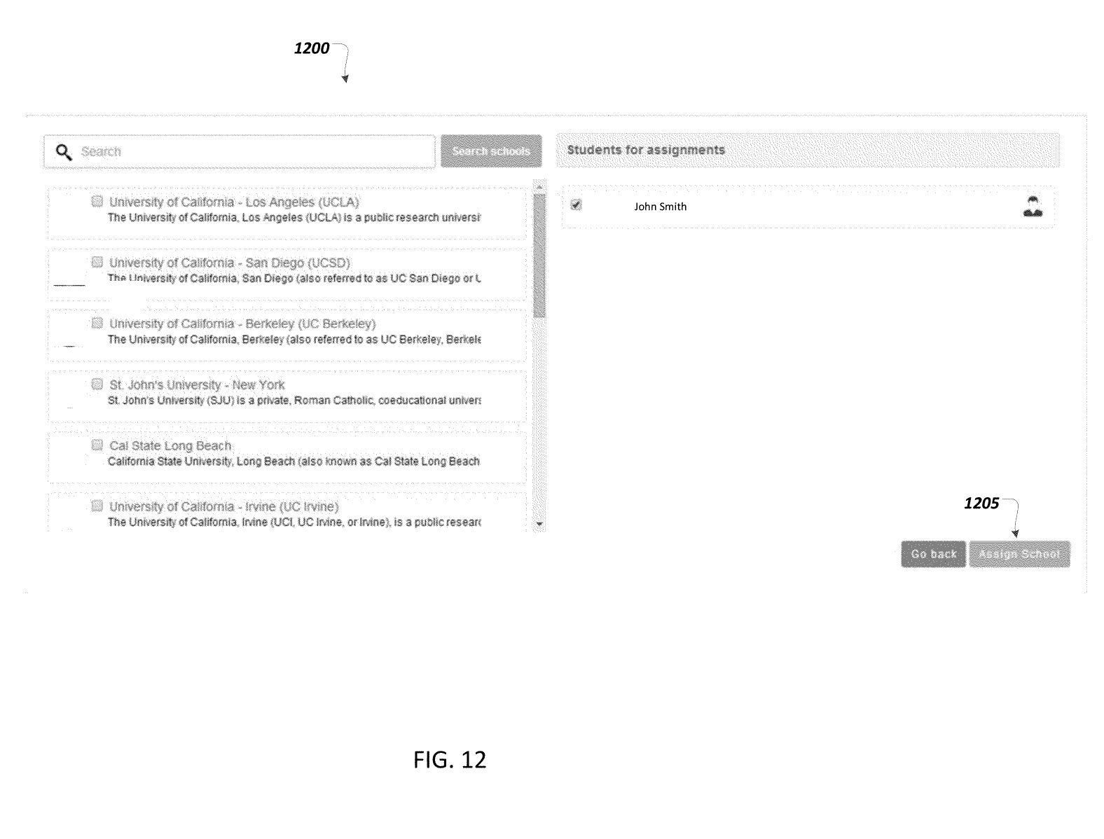

FIG. 12 illustrates an example screen shot 1200 of the essay management and message routing system. Screen 1200 illustrates a school selection screen for John Smith, a student. A counselor can add a school to a student's college list by clicking on the box to the left of the student's name, then clicking the green “Assign schools” button 1205. The counselor will be taken to a school search window. The counselor can search for schools using the search box. If the counselor would like to view admissions stats and other info about a school, then the counselor can click on the school name. When the counselor is ready to add a school to the student's list, the counselor can click the little box to the left of the school name and click the green “Assign school” button 1205.

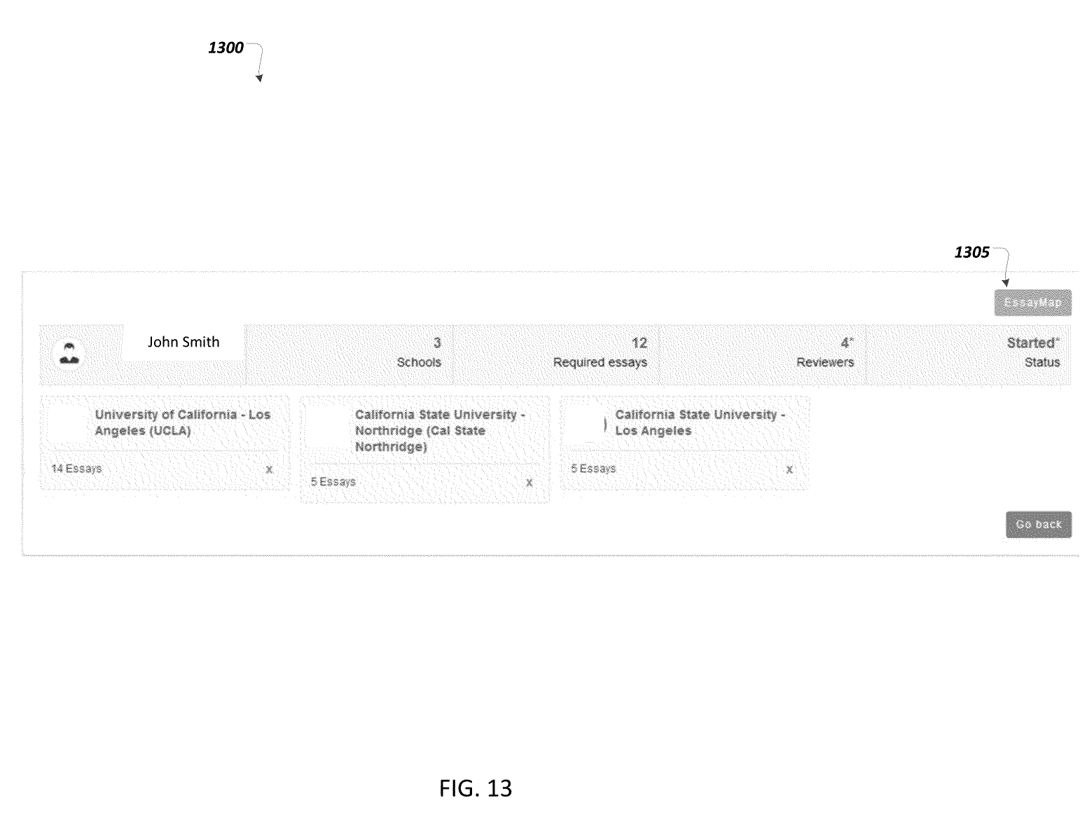

FIG. 13 illustrates an example screen shot 1300 of the essay management and message routing system. Screen 1300 illustrates a selected schools screen for John Smith, a student. The counselor can create a report containing all of the essay and deadline requirements for a student's school list. From the counselor dashboard, click on the first or last name of the student to navigate to the student dashboard area illustrated by screen 1300. Click on the green EssayMap button to create a report that contains the essay requirements for each school for a particular student. Print, email, or view the EssayMap online. The user can also click the “Balance my List” button, which caused the system to compare any available grade point average and standardized test information for the student with admissions criteria published by the schools on his/her list, identifying which schools are likely or unlikely to admit the student. If the student's list contains a predominance of schools that are likely to admit him/her, the system will suggest to the user that the list be diversified to include a higher ratio of selective schools to which admission is less likely. If the student's list contains a predominance of schools that are unlikely to admit him/her, the system will suggest to the user that the list be diversified to include a higher ratio of less selective schools to which admissions is more likely.

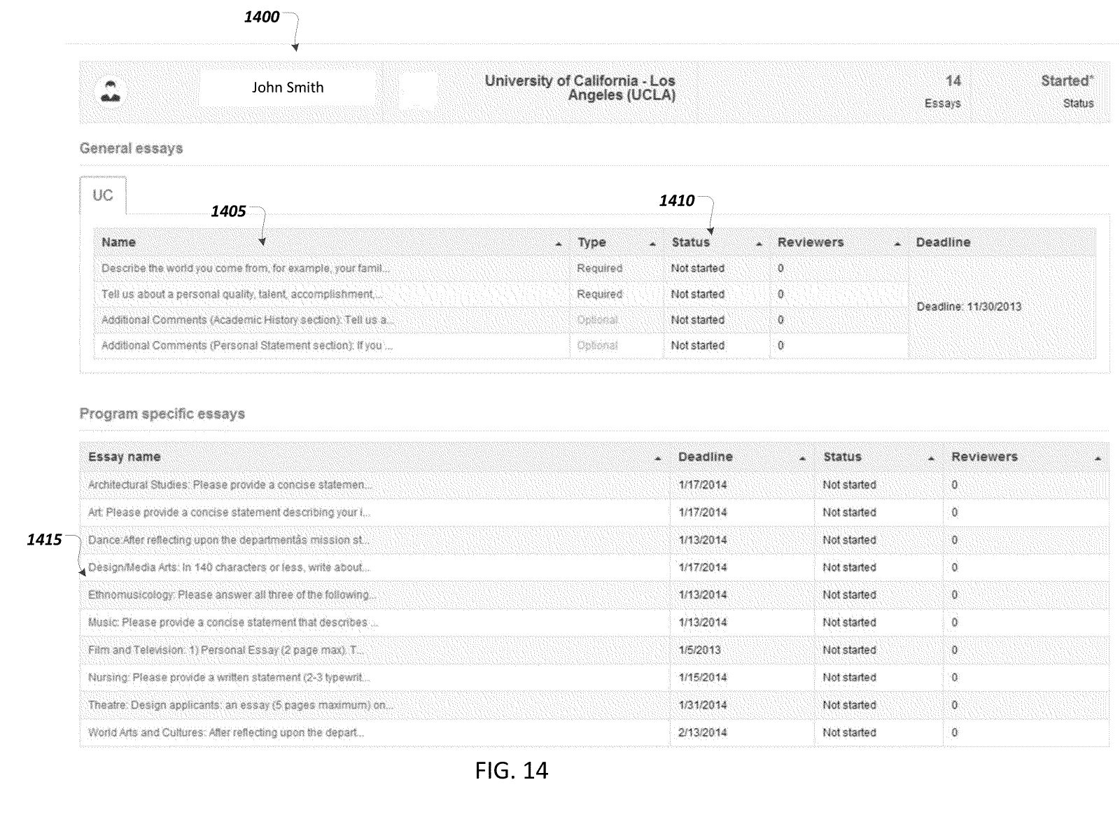

FIG. 14 illustrates an example screen shot 1400 of the essay management and message routing system. Screen 1400, which is similar to screen 400 but for a counselor instead of a student, illustrates essay progress for a particular student with respect to a particular school, in this instance, John Smith at UCLA. In screen 1400, the counselor can view all of the essay requirements for a particular school in column 1405. Column 1410 shows the progress that the selected student has made on each essay. Table 1415 lists program specific essays. Different programs within a particular school may have different essay requirements and those essays are listed in table 1415. The counselor will also be able to see whether an essay is required or optional.

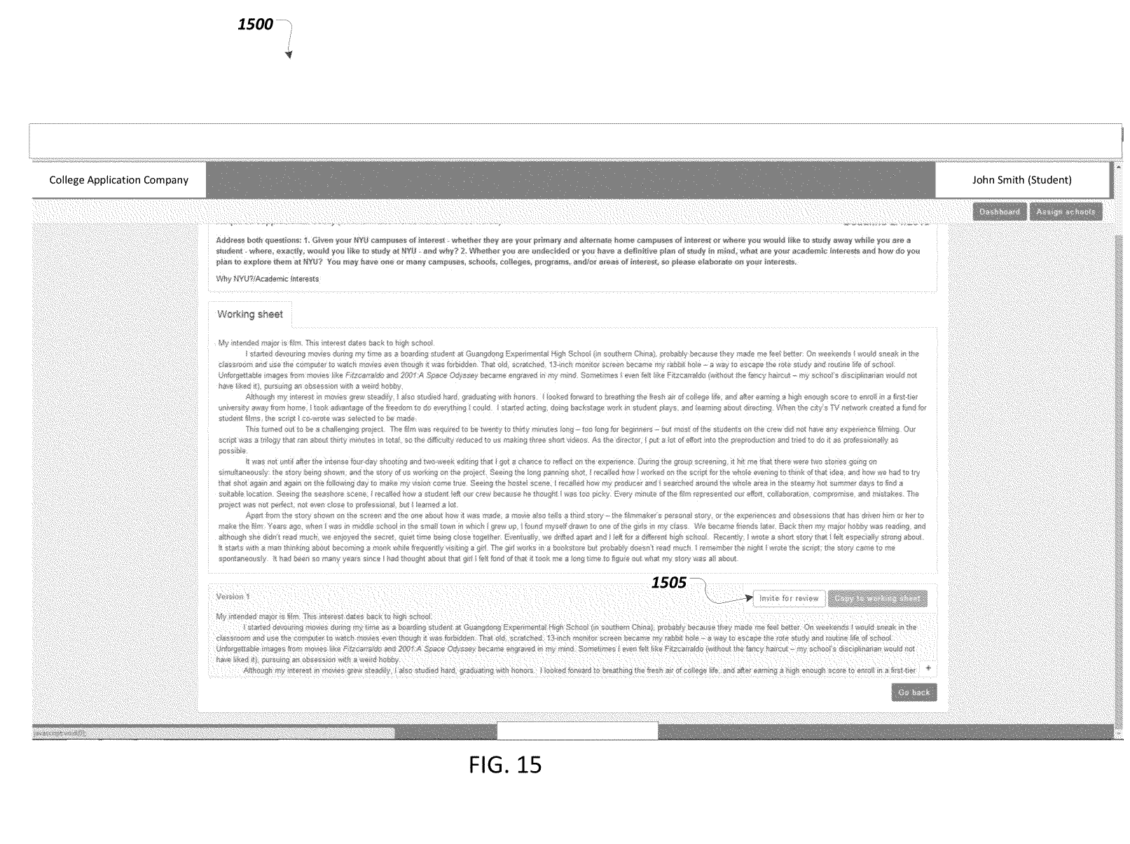

FIG. 15 illustrates an example screen shot 1500 of the essay management and message routing system. Screen 1500 illustrates the current essay draft for a student responding to an essay question, in this instance, John Smith is the student. The counselor can view a student's essay drafts by entering a student's dashboard, selecting a school, and clicking on the essay. All drafts for the selected essay are visualized in a feed-style format in chronological order, accomplishing automated version control such that it may be difficult for a user to not know what the current draft is and allowing the user to easily compare the content of different versions. The prompt of the essay question is displayed on the page, allowing the user to identify the requirement, all historic drafts, all drafts uploaded by reviewers, and the most current draft, all on the same page.

If the counselor would like to review and send feedback to a student, then the counselor can request that the student invite the counselor as a reviewer. A student can do this by clicking the green “Invite for review” button 1505 for any of the saved drafts. When a student invites a counselor, the counselor will receive an email with a link to a text editor where the counselor can edit the draft and send it back to the student. The edited version will show up along with all of the student's drafts in the page for the essay that the counselor is working on. Alternatively, a student can invite a counselor to review a draft or all of the drafts for a school by clicking the button “invite counselor to review.” The “invitation” is represented as a symbol or color-coded shape in the row in the counselor dashboard for that student (instead of an email), alerting the counselor to the invite. The counselor can sort the dashboard to display only the students who have sent these invitations, allowing the counselor to quickly identify which students who are requesting review.

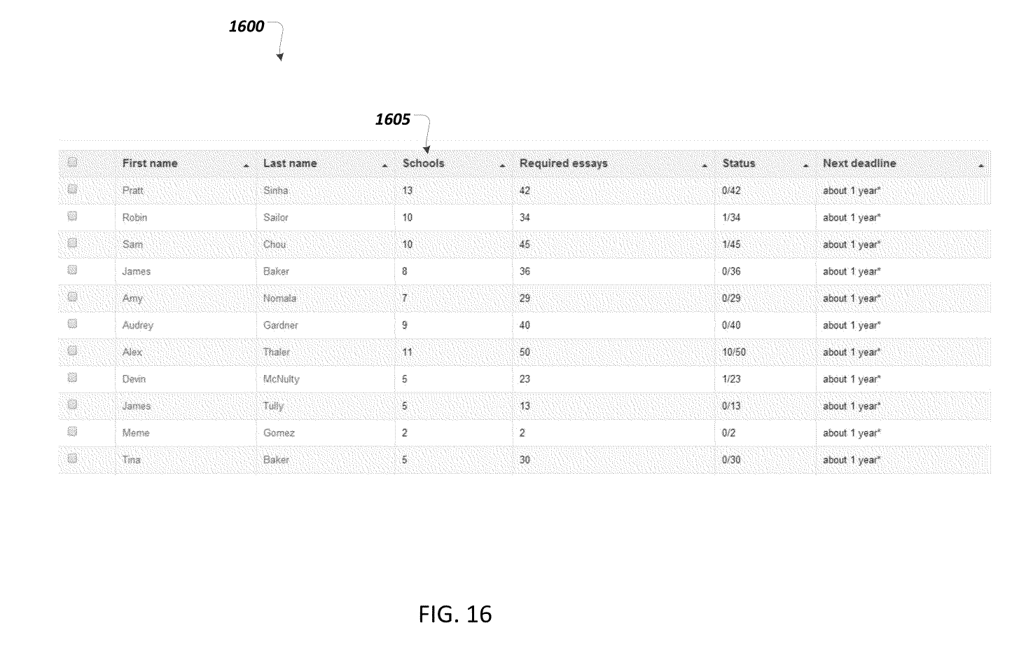

FIG. 16 illustrates an example screen shot 1600 of the essay management and message routing system. Screen 1600 illustrates the counselor dashboard. The counselor dashboard allows the counselor to track student progress throughout the college application process. Every column in the table is sortable from least to greatest. For example, if the counselor wants to see the students who do not have any schools on their list, then the counselor can click on the “schools” column heading 1605 to sort the table from least to greatest. The counselor can also sort by first name, last name, required essays, status, grade point average, standardized test score, and any other metric used generally by institutions of higher education to evaluate applications for admission by clicking the corresponding column headers. The status of other college application requirements, such as the completion of course requirements, standardized tests, financial aid applications, etc. may also be represented in the dashboard. The application essay management and message routing system tracks student progress for each of these application requirements, allowing the counselor to sort the table by overall progress throughout the college application.

The Essay Management system also includes an automated alert system that determines when a student is in danger of missing an application deadline. When a user adds a college to a list, the applicable deadline is assigned to the student.

A predetermined length of time prior to each assigned deadline, the Essay Management System determines whether the student has created versions for the required essays for the college whose deadline is approaching. Because document creation and management is automated, the check is accurate and prevents user error.

If a version has not been created for a required essay, a warning is issued to the user prompting them to complete a draft of the applicable required essay. If a version has been created but the number of words entered is less than about 50% of the maximum allowed word count, a warning is issued to the user prompting them to finalize their essay if they have not already done so. In some implementations, warnings are routed to the assigned counselor. In some implementations, instead of the maximum allowed word count, a typical word count is used. The typical word count may be an average of previously submitted essays for the essay prompt.

There system provides the tools for 1) automated tracking of student progress throughout the application essay writing process, and 2) performing highly accurate checks of student progress relative to a deadline. Because the application essay is often viewed as the most time-intensive aspect of college applications, this system helps to solve a salient challenge associated with the timely completion of those applications, both from student and counselor perspectives.

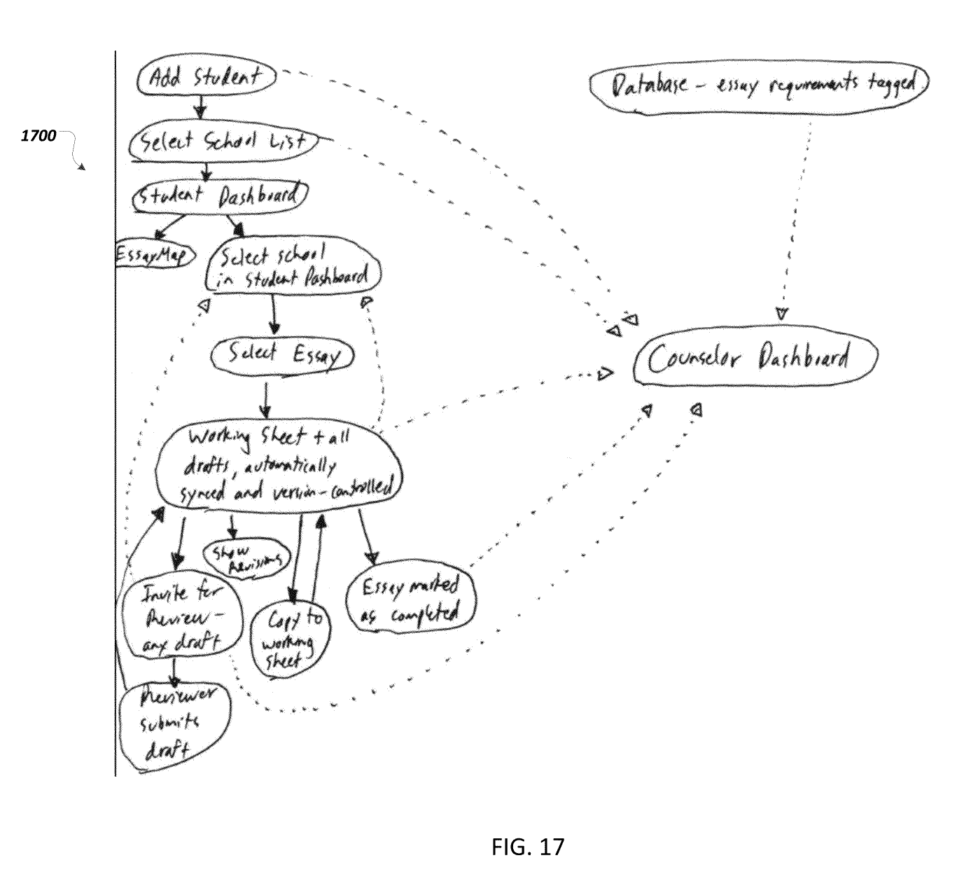

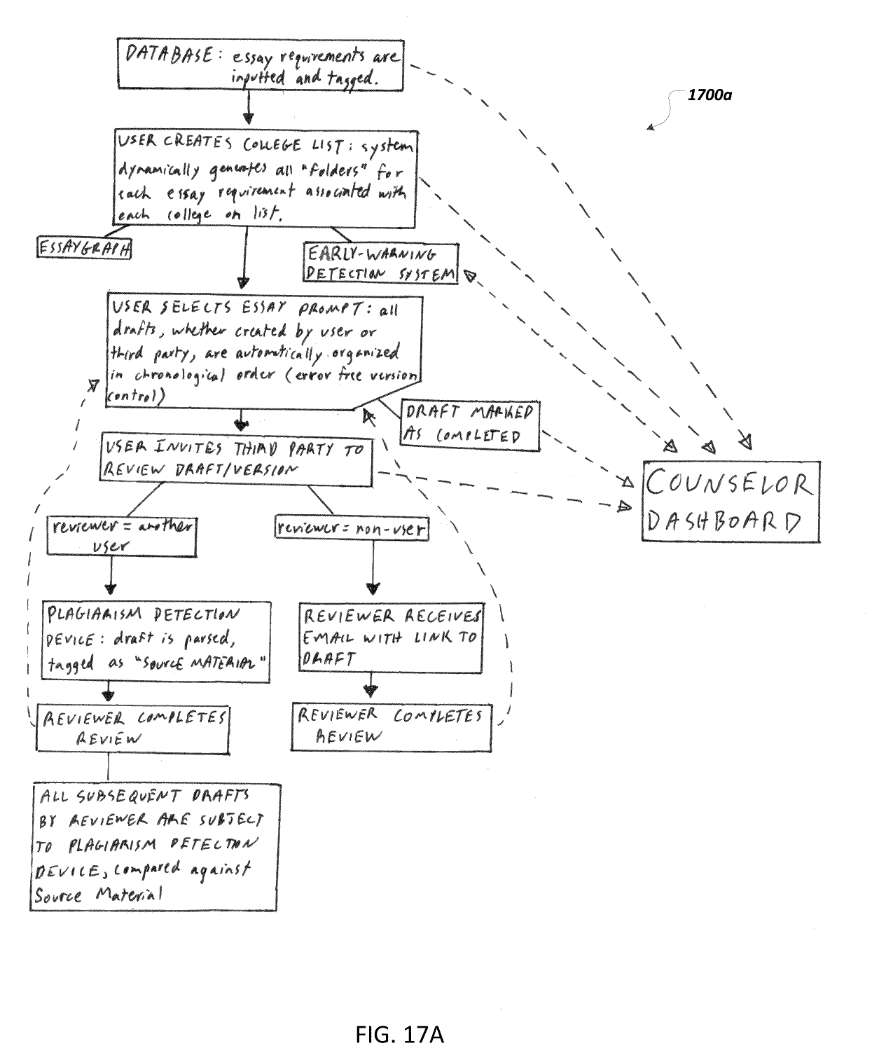

FIG. 17 is a flow chart of an example process 1700 for routing messages. The process 1700 illustrates the stages of essay editing for a student and the stages that can be viewed by the counselor.

FIG. 17A is a flow chart of an example process 1700a for routing messages. The process 1700a illustrates the stages of essay editing for a student and the stages that can be viewed by the counselor as well as plagiarism detection and deadline warnings.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A computer-implemented method comprising:
receiving one or more essay drafts in response to an essay prompt that is provided by an online college application;
determining one or more subject-verb pairs and one or more adjective-noun pairs for the one or more essay drafts by parsing the one or more essay drafts;
storing the one or more essay drafts and the one or more subject-verb pairs and one or more adjective-noun pairs for the one or more essay drafts;
receiving an additional essay draft in response to an additional essay prompt that is provided by an additional online college application;
determining one or more additional subject-verb pairs and one or more additional adjective-noun pairs for the additional essay draft by parsing the additional essay draft;
determining a correlation score between (i) the one or more additional subject-verb pairs and the one or more additional adjective-noun pairs and (ii) the one or more subject-verb pairs and the one or more adjective-noun pairs;
determining whether the correlation score satisfies a threshold correlation score; and
based on determining whether the correlation score satisfies the threshold correlation score, determining whether to label the additional essay draft as disguised plagiarism that indicates the additional essay draft includes similar subject-verb and adjective-noun structures without including identical words.

2. The method of claim 1, comprising:
based on determining whether to label the additional essay draft as disguised plagiarism, determining a text string score between text strings from the one or more essay drafts and additional text strings from the additional essay draft;
determining whether the text string score satisfies a threshold text string score; and
based on determining whether the text string score satisfies the threshold text string score, determining whether to label the additional essay draft as actual plagiarism that indicates word for word similarities between the additional essay draft and the one or more essay drafts.

3. The method of claim 2, wherein:
determining whether the correlation score satisfies a threshold correlation score comprises determining that the correlation score satisfies a threshold correlation score,
determining whether to label the additional essay draft as actual plagiarism comprises determining to label the additional essay draft as actual plagiarism, and
the method further comprises preventing a user who previously edited the additional essay draft from further editing the additional essay draft.

4. The method of claim 1, wherein:
determining whether the text string score satisfies a threshold text string score comprises determining that the text string score satisfies a threshold text string score,
determining whether to label the additional essay draft as disguised plagiarism comprises determining to label the additional essay draft as disguised plagiarism, and
the method further comprises providing, for output, a disguised plagiarism warning to a user who previously edited the additional essay draft that indicates to the user possible disguised plagiarism.

5. The method of claim 1, wherein the online college application is an application to apply to a first institution and the additional college application is an application to apply to a second, different institution.

6. The method of claim 1, comprising:
receiving, from a user inputting the additional essay draft, a request for an additional user to review the additional essay draft, the request including an email address of the additional user.

7. The method of claim 1, comprising:
receiving data indicating a deadline associated with the additional essay draft;
determining whether a number of days between a current date and the deadline satisfies a deadline threshold; and
based on determining whether the number of days between the current date and the deadline satisfies the deadline threshold, determining whether to provide, for output, a deadline warning.

8. The method of claim 1, comprising:
receiving data indicating a maximum word count for an essay prompt associated with the additional essay draft;
determining whether a word count difference between a current word count for the additional essay draft and the maximum word count satisfies a word count threshold; and
based on determining whether the word count difference between the current word count for the additional essay draft and the maximum word count satisfies the word count threshold, determining whether to provide, for output, a word count warning.

9. A system comprising:
one or more computers and one or more storage devices storing instructions that are operable, when executed by the one or more computers, to cause the one or more computers to perform operations comprising:
receiving one or more essay drafts in response to an essay prompt that is provided by an online college application;
determining one or more subject-verb pairs and one or more adjective-noun pairs for the one or more essay drafts by parsing the one or more essay drafts;
storing the one or more essay drafts and the one or more subject-verb pairs and one or more adjective-noun pairs for the one or more essay drafts;
receiving an additional essay draft in response to an additional essay prompt that is provided by an additional online college application;
determining one or more additional subject-verb pairs and one or more additional adjective-noun pairs for the additional essay draft by parsing the additional essay draft;
determining a correlation score between (i) the one or more additional subject-verb pairs and the one or more additional adjective-noun pairs and (ii) the one or more subject-verb pairs and the one or more adjective-noun pairs;
determining whether the correlation score satisfies a threshold correlation score; and
based on determining whether the correlation score satisfies the threshold correlation score, determining whether to label the additional essay draft as disguised plagiarism that indicates the additional essay draft includes similar subject-verb and adjective-noun structures without including identical words.

10. The system of claim 9, wherein the operations further comprise:
based on determining whether to label the additional essay draft as disguised plagiarism, determining a text string score between text strings from the one or more essay drafts and additional text strings from the additional essay draft;
determining whether the text string score satisfies a threshold text string score; and
based on determining whether the text string score satisfies the threshold text string score, determining whether to label the additional essay draft as actual plagiarism that indicates word for word similarities between the additional essay draft and the one or more essay drafts.

11. The system of claim 10, wherein the operations further comprise:
determining whether the correlation score satisfies a threshold correlation score comprises determining that the correlation score satisfies a threshold correlation score,
determining whether to label the additional essay draft as actual plagiarism comprises determining to label the additional essay draft as actual plagiarism, and
the method further comprises preventing a user who previously edited the additional essay draft from further editing the additional essay draft.

12. The system of claim 9, wherein the operations further comprise:
determining whether the text string score satisfies a threshold text string score comprises determining that the text string score satisfies a threshold text string score,
determining whether to label the additional essay draft as disguised plagiarism comprises determining to label the additional essay draft as disguised plagiarism, and
the method further comprises providing, for output, a disguised plagiarism warning to a user who previously edited the additional essay draft that indicates to the user possible disguised plagiarism.

13. The system of claim 9, wherein the online college application is an application to apply to a first institution and the additional college application is an application to apply to a second, different institution.

14. The system of claim 9, wherein the operations further comprise:
receiving, from a user inputting the additional essay draft, a request for an additional user to review the additional essay draft, the request including an email address of the additional user.

15. The system of claim 9, wherein the operations further comprise:
receiving data indicating a deadline associated with the additional essay draft;
determining whether a number of days between a current date and the deadline satisfies a deadline threshold; and
based on determining whether the number of days between the current date and the deadline satisfies the deadline threshold, determining whether to provide, for output, a deadline warning.

16. The system of claim 9, wherein the operations further comprise:
receiving data indicating a maximum word count for an essay prompt associated with the additional essay draft;
determining whether a word count difference between a current word count for the additional essay draft and the maximum word count satisfies a word count threshold; and
based on determining whether the word count difference between the current word count for the additional essay draft and the maximum word count satisfies the word count threshold, determining whether to provide, for output, a word count warning.

17. A non-transitory computer-readable medium storing software comprising instructions executable by one or more computers which, upon such execution, cause the one or more computers to perform operations comprising:
receiving one or more essay drafts in response to an essay prompt that is provided by an online college application;
determining one or more subject-verb pairs and one or more adjective-noun pairs for the one or more essay drafts by parsing the one or more essay drafts;
storing the one or more essay drafts and the one or more subject-verb pairs and one or more adjective-noun pairs for the one or more essay drafts;
receiving an additional essay draft in response to an additional essay prompt that is provided by an additional online college application;
determining one or more additional subject-verb pairs and one or more additional adjective-noun pairs for the additional essay draft by parsing the additional essay draft;
determining a correlation score between (i) the one or more additional subject-verb pairs and the one or more additional adjective-noun pairs and (ii) the one or more subject-verb pairs and the one or more adjective-noun pairs;
determining whether the correlation score satisfies a threshold correlation score; and
based on determining whether the correlation score satisfies the threshold correlation score, determining whether to label the additional essay draft as disguised plagiarism that indicates the additional essay draft includes similar subject-verb and adjective-noun structures without including identical words.

18. The medium of claim 17, wherein the operations further comprise:
based on determining whether to label the additional essay draft as disguised plagiarism, determining a text string score between text strings from the one or more essay drafts and additional text strings from the additional essay draft;
determining whether the text string score satisfies a threshold text string score; and
based on determining whether the text string score satisfies the threshold text string score, determining whether to label the additional essay draft as actual plagiarism that indicates word for word similarities between the additional essay draft and the one or more essay drafts.

19. The medium of claim 17, wherein the operations further comprise:
determining whether the text string score satisfies a threshold text string score comprises determining that the text string score satisfies a threshold text string score,
determining whether to label the additional essay draft as disguised plagiarism comprises determining to label the additional essay draft as disguised plagiarism, and
the method further comprises providing, for output, a disguised plagiarism warning to a user who previously edited the additional essay draft that indicates to the user possible disguised plagiarism.

20. The medium of claim 17, wherein the online college application is an application to apply to a first institution and the additional college application is an application to apply to a second, different institution.
